(19) United States
(12) Patent Application Publication
(10) Pub. No.: US 2004/0122633 A1
(43) Pub. Date: Jun. 24, 2004

(54) Method for updating IKONOS RPC data by additional GCP

(76) Inventors: Ki In Bang, Iksan-si (KR); Ji Hun Seo, Pyeongchang-gun (KR); Soo Jeong, Daejeon (KR); Kyung Ok Kim, Daejeon (KR)

Correspondence Address: JACOBSON HOLMAN PLLC, 400 SEVENTH STREET N.W., SUITE 600, WASHINGTON, DC, 20004, US

(21) Appl. No.: 10/609,664

(22) Filed: Jul. 1, 2003

(30) Foreign Application Priority Data
Dec. 21, 2002 (KR) 10-2002-0082203

(51) Int. Cl. G06F 17/10

(52) U.S. Cl. 703/2

(57) ABSTRACT

More precise topology information can be extracted from satellite images by improving the accuracy of RPC parameter data for a RFM sensor model by using only a small number of GCPs. That is, the number of GCPs required for extracting the topology information can be reduced by generating pseudo GCPs from the RPC data or composing a parameter observation equation by using the RPC data. Therefore, costs and time for actually measuring GCPs can be saved. Furthermore, since the present invention utilizes the RFM sensor model using RPC files, a new sensor model need not be required.

### FIELD OF THE INVENTION

The present invention relates to a method for obtaining topology information by using satellite images; and, more particularly, to a method for improving the accuracy of parameters provided with IKONOS satellite images by using a small number of ground control points (GCPs) to thereby extract precise topology information from the IKONOS satellite images having spatial resolution of about 1 m.

### BACKGROUND OF THE INVENTION

In general, IKONOS satellite images are optical images featuring high spatial resolution of about 1 m. Unlike other satellite images such as SPOT and KOMPSAT, the IKONOS satellite images do not provide satellite navigation data or sensor (satellite) attitude. Instead, the IKONOS satellite images offer a parameter called a rational polynomial coefficient (RPC) in order to use a rational function model (RFM) as a mathematical sensor model. An end user of the IKONOS images can obtain 3D position or geospatial information of objects in the images by using the RPC data.

If, however, the user requests geospatial information having an accuracy higher than that of the RPC, a more precise sensor model should be constructed by acquiring many GCPs in a region represented by the images, which is very difficult and troublesome. In fact, the acquisition of the GCPs involves a great amount of costs, time and effort. Furthermore, even if the additional GCPs are obtained, it is very difficult for the user to properly apply a new sensor model.

### SUMMARY OF THE INVENTION

It is, therefore, an object of the present invention to provide a method for accurately updating IKONOS RPC data by employing a small number of additional GCPs.

In accordance with one aspect of the present invention, there is provided a method for updating IKONOS RPC data by using a small number of GCPs, the method including the steps of:

(a) receiving the RPC data and coordinate values of the GCPs;

(b) calculating an error of the RPC data;

(c) calculating weights of pseudo GCPs, wherein the pseudo GCPs are extracted from the RPC data in normalized cubic;

(d) calculating weights of the GCPs;

(e) generating a 3D normalized space and extracting 3D normalized coordinate values of the GCPs and the pseudo GCPs;

(f) creating an RFM observation equation by using the GCPs and the pseudo GCPs and updating the RPC data by a least square technique.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram of an RPC data updating module in accordance with the present invention;

FIG. 2 provides a flowchart of an RPC data updating process in accordance with a first preferred embodiment of the present invention;

FIG. 3 offers a flowchart of an RPC data updating process using pseudo ground control points (pseudo GCPs) in accordance with a second preferred embodiment of the present invention;

FIG. 4 illustrates a 3D normalized space in which the pseudo GCPs are distributed; and

FIG. 5 shows a flowchart of an RPC data updating process using a parameter equation generated from the RPC data in accordance with a third preferred embodiment of the present invention.

### DETAILED DESCRIPTION OF THE PREFERRED EMBODIMENT

IKONOS satellite images provide to a user a rational polynomial coefficient (RPC), i.e., a parameter required for a rational function model (RFM), instead of supplementary data for the sensor model. The RPC includes all the parameters required for a RFM sensor model. The RPC also has an offset and a scale for coordinates since it uses normalized coordinates.

The normalized coordinates refer to 2D image coordinates and 3D ground coordinates transformed within the range from −1.0 to +1.0. Accordingly, even if original coordinates are moved by a specific value, all of the coordinate values may be defined within a certain range by adjusting the scale of the coordinate values.

The user of the IKONOS satellite images can obtain geospatial information of an object shown in the images by inputting the parameter required for the RFM sensor model by using the RPC. Further, the user can be informed of the location of an object on the IKONOS images by inputting 3D ground coordinates. Eq. 1 shows a general form of the RFM while Eq.2 represents a method for moving coordinates by a specific value and normalizing the coordinates by using a scale.

$$x = \frac{{f}_{1} ( u , v , w )}{{f}_{2} ( u , v , w )} \\ y = \frac{{f}_{3} ( u , v , w )}{{f}_{4} ( u , v , w )} \\ f ( u , v , w ) = {\sum }_{i = 0}^{3} {\sum }_{j = 0}^{3} {\sum }_{k = 0}^{3} {a}_{n} {u}^{i} {v}^{j} {k}^{k} = {a}_{0} + {a}_{1} v + {a}_{2} u + {a}_{3} w + {a}_{4} uv + {a}_{5} vw + {a}_{6} uw + {a}_{7} {v}^{2} + {a}_{8} {u}^{2} + {a}_{9} {w}^{2} + {a}_{10} uvw + {a}_{11} {v}^{3} + {a}_{12} {vu}^{2} + {a}_{13} {vw}^{2} + {a}_{14} {uv}^{2} + {a}_{15} {u}^{3} + {a}_{16} {uw}^{2} + {a}_{17} {v}^{2} w + {a}_{18} {u}^{2} w + {a}_{19} {w}^{3} \\ ( i + j + k ) \leq 3 \\ ( n = 0 ∼ 19 ) \qquad Eg . 1$$

u=(Lat−O_{Lat})/S_{Lat}

v=(Lon−O_{Lon})/S_{Lon}

w=(H−O_{H})/S_{H} Eg. 2

y=(Row−O_{Row})/S_{Row}

x=(Col−O_{Col})/S_{Col}

If the RPC provided with the IKONOS images does not satisfy the accuracy level demanded by the user, the user should update the RPC to obtain the desired accuracy. In general, tens of GCPs should be measured in a target region in order to obtain geospatial information with higher preciseness so that a parameter of sensor model selected by the user should be calculated and the relationship between 2 dimensional image and 3 dimensional real space must be defined. However, even if there exists only one GCP, the RPC data can be updated with a higher preciseness in accordance with the present invention.

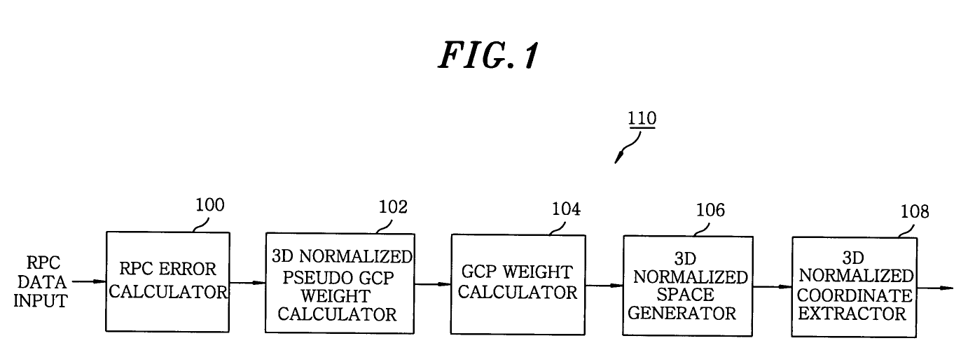

Referring to FIG. 1, there is provided a block diagram of an IKONOS RPC data updating software module 110 (hereinafter referred to as RPC data updating module 110) using a small number of GCPs in accordance with the present invention. The RPC data updating module 110 operates to update the RPC with a least square technique by using a small number of GCPs.

The RPC data updating module 110 includes an RPC error calculator 100, a 3D normalized pseudo GCP weight calculator 102, a GCP weight calculator 104, a 3D normalized space generator 106 and a 3D normalized coordinates extractor 108. The RPC error calculator 100 receives the parameter, i.e., RPC, for converting IKONOS satellite images into ground coordinates and calculates errors of the RPC data. The 3D normalized pseudo GCP weight calculator 102 computes 3D normalized pseudo GCP weights for pseudo GCPs generated from the RPC data. The GCP weight calculator 104 calculates weights of a small number of GCPs. The 3D normalized space generator 106 creates a 3D normalized space for applying the GCPs and the pseudo GCPs. The 3D normalized coordinates extractor 108 extracts 3D coordinates in the 3D normalized space for the GCPs and the pseudo GCPs.

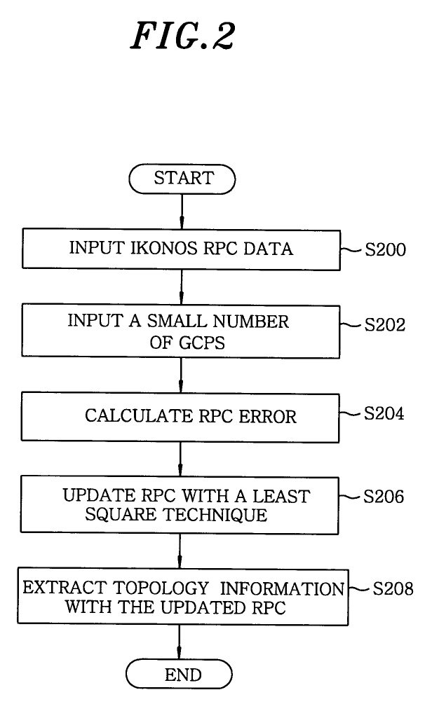

FIG. 2 shows a flowchart of an IKONOS RPC data updating process using a small number of GCPs in accordance with a first preferred embodiment of the present invention.

The RPC data updating module 110 inputs the IKONOS RPC data in Step S200 and also inputs in Step S202 a small number of GCPs already prepared. The GCPs may be obtained from an image of the target region for which the GCPs have been already obtained or by using coordinates on a digital map offered by a geography institute.

The RTC data updating module 110 calculates the errors of the RPC data by using the GCPs in Step S204. The GCPs are used to correct the errors of the RPC data. As mentioned above, the present invention enables to correct the errors of the RPC by using the minimum number of GCPs. The estimation of the RPC error is very important in calculating the reliability of the RPC data. The reliability of the RPC data is used as a weight of the RPC data in order to update the RPC data by a least square technique. That is, the existing RPC data should be modified a lot if its reliability is low, while the degree of modification is low if its reliability is high. Thus, the reliability of the RPC data serves to determine the degree of modification in updating the RPC data.

After the Step S204 is completed, the RPC data updating module 110 updates the RPC data by employing the least square technique in Step S206 and, then, extracts the desired topology information by using the updated RPC data (S208).

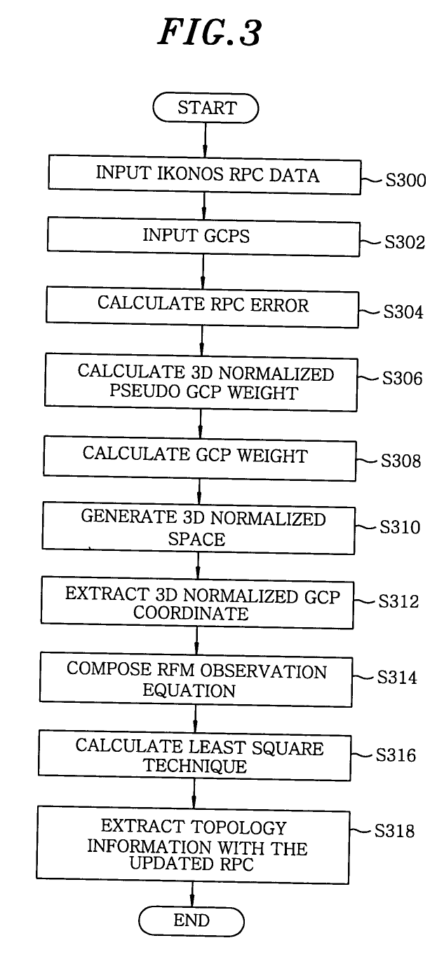

FIG. 3 sets forth a flowchart of an IKONOS RPC data updating process using a small number of GCPs in accordance with a second preferred embodiment of the present invention.

First, the RPC data updating module 110 inputs the IKONOS RPC data in Step S300 and also inputs in Step S302 a small number of GCPs already prepared.

Then, the RPC data updating module 110 calculates errors of the RPC data by using the GCPs in Step S304 and estimates 3D normalized pseudo GCP weights for pseudo GCPs generated by using the RPC data (S306).

In other words, the pseudo GCPs may be generated by using the RPC so as to make up for the small number of GCPs. The RPC may be used to transform image coordinates to ground coordinates so that the ground coordinates may be used as the pseudo GCPs.

The total number of the GCPs and the pseudo GCPs required for applying the least square technique may be obtained by using a small number of GCPs which is substantially true and the pseudo GCPs gained from the images containing the errors. If the pseudo GCPs are set to have weights identical with those of the actually measured small number of GCPs, however, the pseudo GCPs come to have the same errors as contained in the RPC data. Accordingly, even if a mathematical condition for applying the least square technique may be obtained, the RPC data can hardly be updated. In order to resolve this problem, the reliability of the pseudo GCPs are set to be much lower than that of the actually measured GCPs based on the RPC errors calculated in the Step S304, thereby enabling to update the RPC data just by using a small number of GCPs.

After the Step S306 is finished, the RPC data updating module 110 calculates weights of a small number of GCPs in Step S308. Then, the RPC data updating module generates a 3D normalized space in Step S310 and extracts 3D GCP normalized coordinates in Step S312.

As described above, the IKONOS RPC is a parameter for the RFM sensor model and is set based on the assumption that an object to be photographed exists at a space having a limited axis range from −1.0 to 1.0. The image coordinates are also defined within a range from −1.0 to 1.0. Thus, it is necessary that an offset value and a scale value may be used to convert the normalized coordinates in order to obtain WGS84 coordinates of an object shown in an image and a row value or a column value of the image. There are an offset value and a scale value for each row, each column and each latitude, each longitude and each height of the WGS84 coordinates. Eg.2 provides definitions of the offset/scale values. In Eg. 2, u,v,w,y and x refer to a normalized latitude, a normalized longitude, a normalized height, a normalized row and a normalized column, respectively. Since the RPC uses normalized coordinates as can be seen from the above, the pseudo GCPs can be located at the 3D normalized space and the RPC data can be updated by using the GCPS and the pseudo GCPs in the 3D normalized space.

The RPC data updating module 110 composes an RFM observation equation in Step S314 and updates the RPC by performing the least square technique with a small number of GCPs and the pseudo GCPs in Step S316. Then, the RPC data updating module 110 extracts desired topology information by using the updated RPC data.

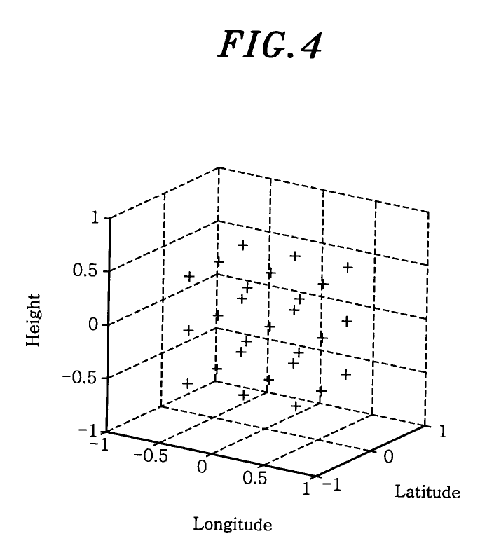

Referring to FIG. 4, there are illustrated GCPs arranged in the 3D normalized space having a cube shape. Each axis therein is defined within the range from −1.0 to 1.0.

Since a small number of GCPs and the pseudo GCPs extracted from the RPC data already prepared are used to update the RPC data in accordance with the present invention, it is preferable that the weights of the GCPs are properly adjusted so that the influence of the GCPs are sufficiently reflected. A weight matrix may be composed by a weight allocated for each observation value and an influence on the GCPs may be determined by the weight matrix. Accordingly, it is preferable that the weights of the GCPs have larger values than those of the pseudo GCPs in the 3D normalized space. In order to determine the weights, measurement errors at a time of acquiring the GCPs may be analyzed and the RPC errors of the original RPC data provided with the IKONOS image may be analyzed by using the GCPs so that the two errors may be compared with each other. By using the new RPC data updated through the processes as described above, highly accurate geospatial information can be extracted from the IKONOS images.

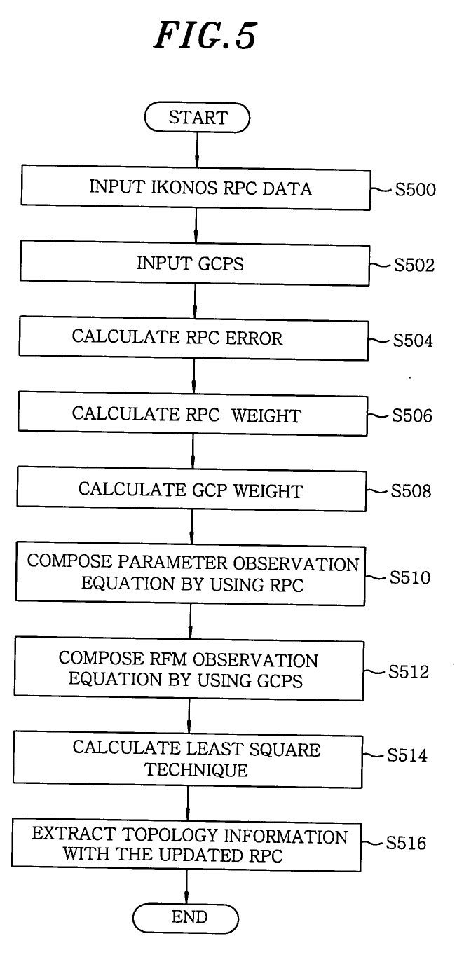

Referring to FIG. 5, there is depicted a flowchart of an IKONOS RPC data updating process using a small number of GCPs in accordance with a third preferred embodiment of the present invention.

The RPC data updating process disclosed in the third preferred embodiment is different from the process described in FIG. 3 in which the equations for use in updating the RPC are obtained by using a small number of GCPs and the pseudo GCPs installed at the 3D normalized space. In the third embodiment, the RPC provided with the IKONOS images is directly applied to a parameter observation equation.

First, the RPC data updating module 110 inputs the IKONOS RPC data in Step S500 and also inputs in Step S502 a small number of GCPs already prepared. Thereafter, the RPC data updating module 110 calculates errors of the RPC data by using the GCPs in Step S504.

Then, the RPC data updating module 110 composes a parameter observation equation using the RPC data (Step S506). As a result, the number of equations increases to as many as the number of the RPC parameters, so that it the RPC data may be updated by using only a small number of GCPs. Eq. 3 shows a general form of the parameter observation equation.

a <DATASIZE=0>ᵢ=aᵢ₀+Δₐᵢ Eq. 3

Subsequently, the RPC data updating module 110 composes a GCP RFM observation equation, i.e., an RFM observation equation by using the GCPs, in Step 508. Then, the RPC data updating module 110 combines the RFM parameter observation equation and the GCP RFM observation equation to thereby generate equations as many as enough to update the RPC data (S510 and S512) and then applies the least square technique thereto (S514). Eg. 4 shows a matrix of a least square technique generated from the combination of the parameter RFM observation equation and the GCP RFM observation equation.

$$[ \begin{matrix}1 & & & \\ & ⋰ & & \\ & & ⋰ & \\ & & & 1 \\ \frac{\partial F}{\partial {a}_{i}} & ⋯ & \frac{\partial F}{\partial {b}_{i}} & ⋯ \\ \frac{\partial G}{\partial {c}_{i}} & ⋯ & \frac{\partial G}{\partial {d}_{i}} & ⋯ \\ ⋮ & & ⋮ & \end{matrix} ] [ \begin{matrix}\frac{\partial F}{\partial {a}_{i}} \\ ⋮ \\ \frac{\partial F}{\partial {b}_{i}} \\ ⋮ \\ \frac{\partial G}{\partial {c}_{i}} \\ ⋮ \\ \frac{\partial G}{\partial {d}_{i}} \\ ⋮\end{matrix} ] = [ \begin{matrix}{a}_{{1}_{0}} - {da}_{1} \\ ⋮ \\ x - {F}_{0} \\ y - {G}_{0} \\ ⋮\end{matrix} ] + [ \begin{matrix}{V}_{{a}_{1}} \\ ⋮ \\ {V}_{x} \\ {V}_{y} \\ ⋮\end{matrix} ] \qquad Eq . 4$$

The weights of the parameter observation equation is determined by using the errors of the RPC data. Further, the weight of the GCP RFM observation equation may be determined based on a GCP acquisition error or may be set to be larger than the weight of the parameter observation equation, so that the RPC data may be updated by using a small number of GCPs.

As described above, since the pseudo GCP coordinates may be generated from the RPC data or the parameter observation equation may be composed by using the RPC data in accordance with the present invention, the number of GCPs required for extracting the topology information by using the RPC data may be considerably reduced. Therefore, costs and time for actually measuring GCPs can be saved. Furthermore, since the present invention utilizes the RFM sensor model in which RPC files is used, a new sensor model can not be required.

While the invention has been shown and described with respect to the preferred embodiments, it will be understood by those skilled in the art that various changes and modifications may be made without departing from the spirit and scope of the invention as defined in the following claims.

What is claimed is:

1. A method for updating IKONOS rational polynomial coefficient (RPC) data by using a small number of ground control points (GCPs), the method including the steps of:
(a) receiving the RPC data and coordinate values of the GCPs;
(b) calculating an error of the RPC data;
(c) calculating weights of pseudo ground control points (pseudo GCPs), wherein the pseudo GCPs are extracted from the RPC data in 3D normalized cubic;
(d) calculating weights of the GCPs;
(e) generating a 3D normalized space and extracting 3D normalized coordinate values of the GCPs and the pseudo GCPs;
(f) creating a rational functional model (RFM) observation equation by using the GCPs and the pseudo GCPs and updating the RPC data by a least square technique.

2. The method of claim 1, wherein the error of the RPC data is calculated based on the GCPs in the step (b).

3. The method of claim 1, wherein the pseudo GCPs generated from the RPC data have weights with a lower reliability in the step (c).

4. The method of claim 1, wherein the pseudo GCPs and the GCPs are normalized within a range from −1.0 to 1.0.

5. A method for updating IKONOS rational polynomial coefficient (RPC) data by using a small number of ground control points (GCPs), the method comprising the steps of:
(a) receiving the RPC data and coordinate values of the GCPs;
(b) calculating an error of the RPC data;
(c) calculating a weight of the RPC data;
(d) calculating weights of GCPs;
(e) creating a rational function model (RFM) observation equation by using the GCPs;
(f) creating a parameter observation equation by using the RPC data; and
(g) updating the RPC data by a least square technique through the use of the RFM observation equation and the parameter observation equation.

6. The method of claim 5, wherein the error of the RPC data is calculated based on the GCPs in the step (b).

7. The method of claim 5, wherein the parameter observation equation and the RFM observation equation are combined to construct equations equal to or more than those required to update the RPC data by using the least square technique in the step (g).

8. The method of claim 5, wherein the weight of the parameter observation equation is determined based on the error of the RPC data.

9. The method of claim 8, wherein the weight of the RFM observation equation is determined based on a GCP acquisition error.

10. The method of claim 9, wherein the weight of the RFM observation equation is set to be larger than the weight of the parameter observation equation, thereby allowing the RPC data to be updated by the GCPs.
